(19) United States
(12) Patent Application Publication
(10) Pub. No.: US 2014/0340935 A1
(43) Pub. Date: Nov. 20, 2014

(54) BACKLIGHT MODULE HAVING NON-DOT AREA AND LIGHT GUIDE PLATE USING SAME

(71) Applicant: HON HAI PRECISION INDUSTRY CO., LTD., New Taipei (TW)

(72) Inventor: CHEN-HAN LIN, New Taipei (TW)

(73) Assignee: HON HAI PRECISION INDUSTRY CO., LTD., New Taipei (TW)

(21) Appl. No.: 14/093,676

(22) Filed: Dec. 2, 2013

(30) Foreign Application Priority Data
May 20, 2013 (TW) 102117699

(51) Int. Cl. F21V 8/00

(52) U.S. Cl. CPC G02B 6/0043
USPC 362/612; 362/615; 362/623

(57) ABSTRACT

A light guide plate includes a light mixing part and a visual part. The light mixing part includes a light mixing bottom surface, a light incident surface, and a top surface opposite to the light mixing bottom surface. The light incident surface is substantially perpendicular to the light mixing bottom surface and the top surface. The visual part is adjoined to the light mixing part and includes a visual bottom surface and a light emitting surface opposite to the visual bottom surface. The visual bottom surface and the light mixing bottom surface are substantially coplanar and are divided by an imaginary adjoining line. The top surface and the light emitting surface are substantially coplanar. The visual bottom surface has at least one non-dot area. The visual bottom surface forms a plurality of reflective dots except for the non-dot area.

### BACKGROUND

1. Technical Field

The present disclosure relates to a backlight module and a light guide plate used in the backlight module.

2. Description of Related Art

Backlight modules include a light source and a light guide plate. The light guide plate includes a light emitting surface and a reflecting surface opposite to the light emitting surface. Reflective dots are formed on the reflecting surface to reflect and scatter light. As light is usually concentrated at an area of the light surface adjacent to the light source, a bright spot will appear on the area of the light emitting surface adjacent to the light source.

Therefore, it is desirable to provide a light guide plate and a backlight module to overcome the shortcomings mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is schematic, isometric view of a light guide plate according to a first embodiment of the present disclosure.

FIG. 2 is a bottom view of the light guide plate of FIG. 1.

FIG. 3 is a bottom view of a backlight module according to a second embodiment of the present disclosure.

FIG. 4 shows a light intensity distribution of the backlight module of FIG. 3 comparing a light intensity distribution of a prior backlight module with a light intensity distribution of the backlight module of FIG. 3.

FIG. 5 is a schematic, isometric view of a light guide plate according to a third embodiment of the present disclosure.

FIG. 6 is a bottom view of the light guide plate of FIG. 5.

FIG. 7 is a bottom view of a backlight module according to a fourth embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

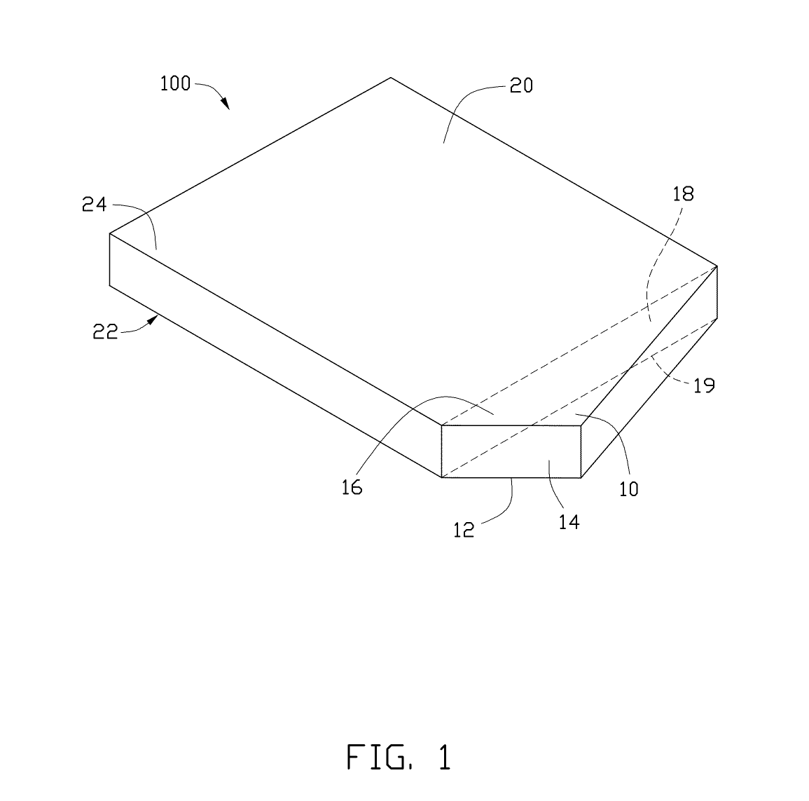

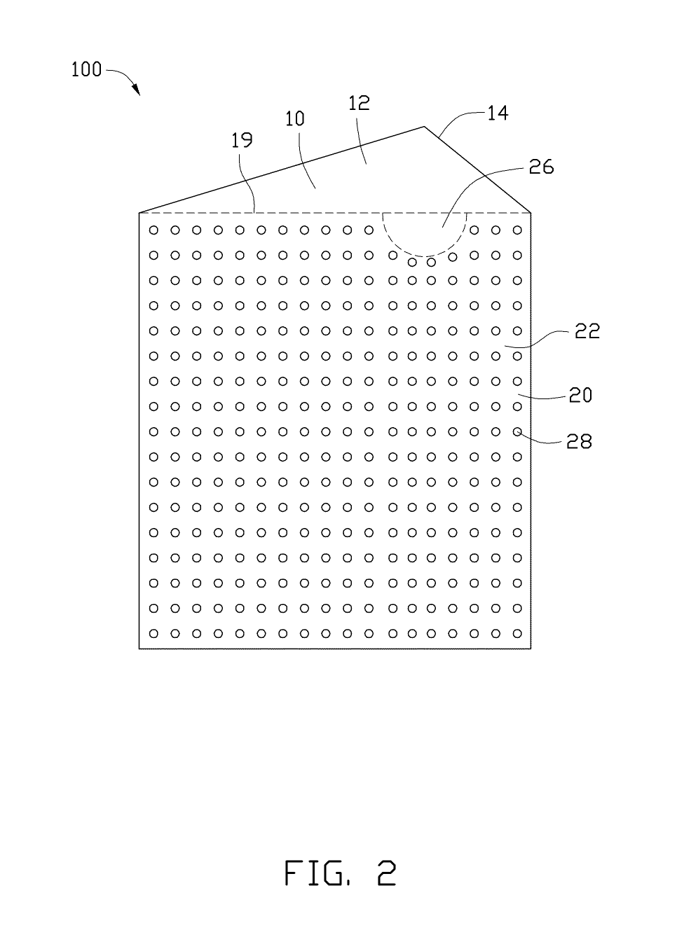

Referring to FIGS. 1 and 2, a light guide plate 100 according to a first embodiment of the present disclosure is shown. The light guide plate 100 includes a light mixing part 10 and a visual part 20 connected to the light mixing part 10. In one embodiment, the light mixing part 10 and the visual part 20 are integrally formed by injection molding.

The light mixing part 10 is a prism. The light mixing part 10 includes a light mixing bottom surface 12, a light incident surface 14, a top surface 16, and an adjoining surface 18. The light mixing bottom surface 12 is opposite to the top surface 16. The light mixing bottom surface 12 and the top surface 16 are substantially triangular. The light incident surface 14 is substantially rectangular and is substantially perpendicular to the light mixing bottom surface 12 and the top surface 16. The light mixing part 10 is connected to the visual part 20 at the adjoining surface 18. The light incident surface 14 is connected to the adjoining surface 18, and an included angle between the light incident surface 14 and the adjoining surface 18 is less than 90 degrees.

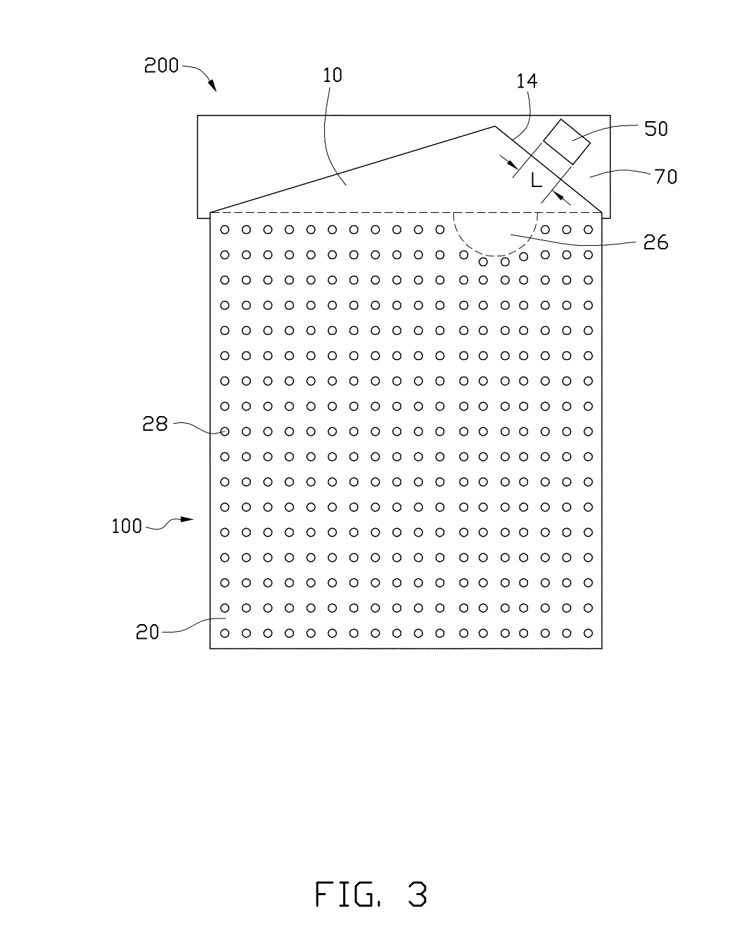

The visual part 20 is a substantially flat plate. The visual part 20 includes a visual bottom surface 22 and a light emitting surface 24. The visual bottom surface 22 is opposite and substantially parallel to the light emitting surface 24. The visual bottom surface 22 is substantially coplanar with the light mixing bottom surface 12. The visual bottom surface 22 and the light mixing bottom surface 12 are divided by an imaginary adjoining line 19. The light emitting surface 24 is substantially coplanar with the top surface 16. The visual bottom surface 22 is covered by a number of reflective dots 28, except for a non-dot area 26. The non-dot area 26 is substantially semi-circular, and a straight edge of the non-dot area 26 is collinear with the imaginary adjoining line 19. A length of the straight edge of the non-dot area 26 is about 1 to about 1.5 times a width of a light source 50 (see FIG. 3).

Referring to FIGS. 1 and 3, a backlight module 200 according to a second embodiment is disclosed. The backlight module 200 includes the light guide plate 100, the light source 50, and a shield part 70.

The light source 50 is located adjacent to the light incident surface 14, and a light emitting surface of the light source 50 faces the light incident surface 14. In one embodiment, the light source 50 is a light emitting diode (LED). A straight line perpendicular to a center of the light emitting surface of the light source 50 extends through a center of the non-dot area 26. Light emitted by the light source 50 enters the light guide plate 100 from the light incident surface 14 and is transmitted to the visual part 20 through the light mixing part 10. In the visual part 20, the light is reflected and scattered by the reflective dots 28 and is emitted out from the light emitting surface 24.

The shield part 70 completely covers the top surface 16. In one embodiment, the shield part 70 also covers the light source 50. The shield part 70 is fixedly mounted on a side frame (not shown) of the backlight module 200. The shield part 70 can be black-colored to absorb light emitted out from the top surface 16 and prevent light from leaking out of the backlight module 200. The shield part 70 can also be a reflecting layer to reflect light emitted out from the top surface 16 back to the light mixing part 10 to increase a usage ratio of the light.

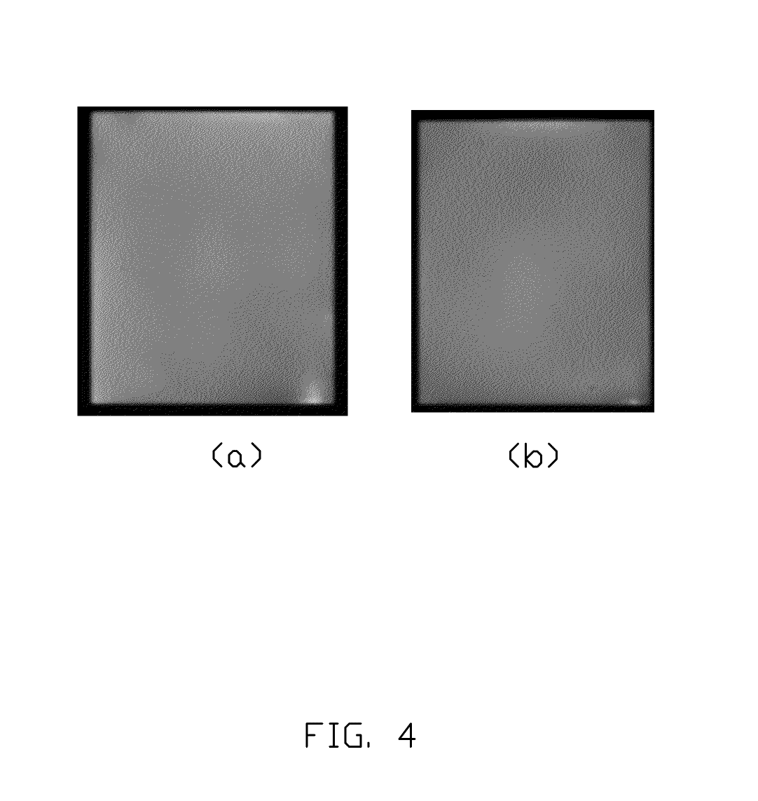

Referring to FIG. 4, FIG. 4(a) shows a light intensity distribution of a conventional backlight module. Due to a visual part of a light guide plate of the prior backlight module has no non-dot area, the visual part has a bright spot (shown at a lower right corner of FIG. 4(a)) adjacent to a light source of the backlight module. FIG. 4(b) shows a light intensity distribution of the backlight module 200, which the bright spot is eliminated or at least reduced.

The visual bottom surface 22 has a non-dot area 26 aligned with the light source 50, so light is not reflected and scattered in the non-dot area 26. Thus, a bright spot can be eliminated or at least reduced. Additionally, the non-dot area 26 is aligned with and adjacent to the light source 50, so there is plenty of light to illuminate the non-dot area 26 to avoid a dark spot from forming. Furthermore, the light guide plate 100 is suitable for use with a single light source.

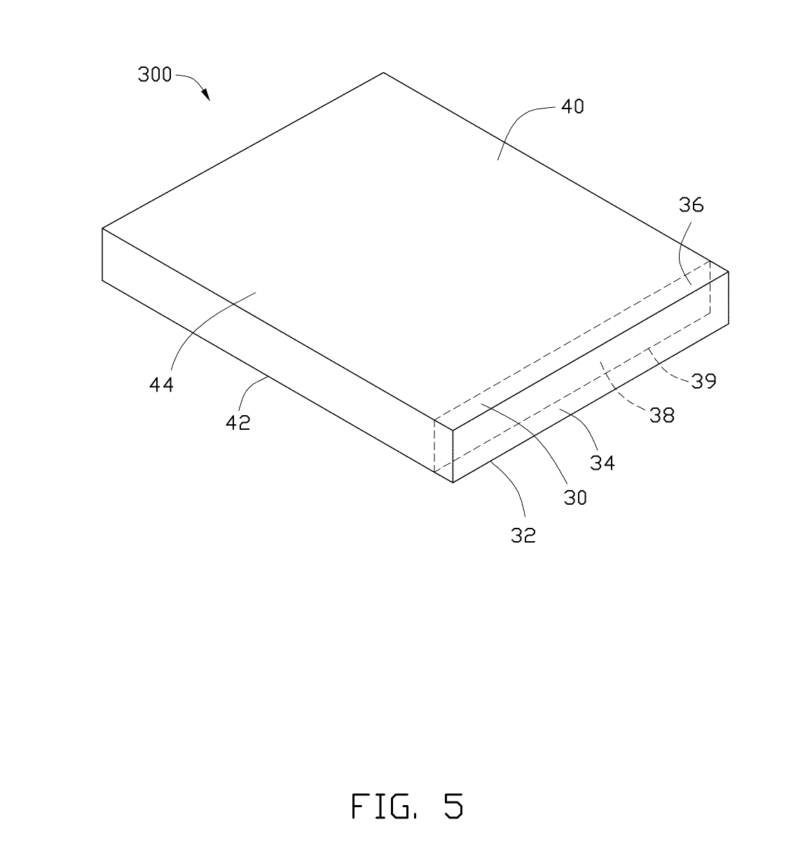

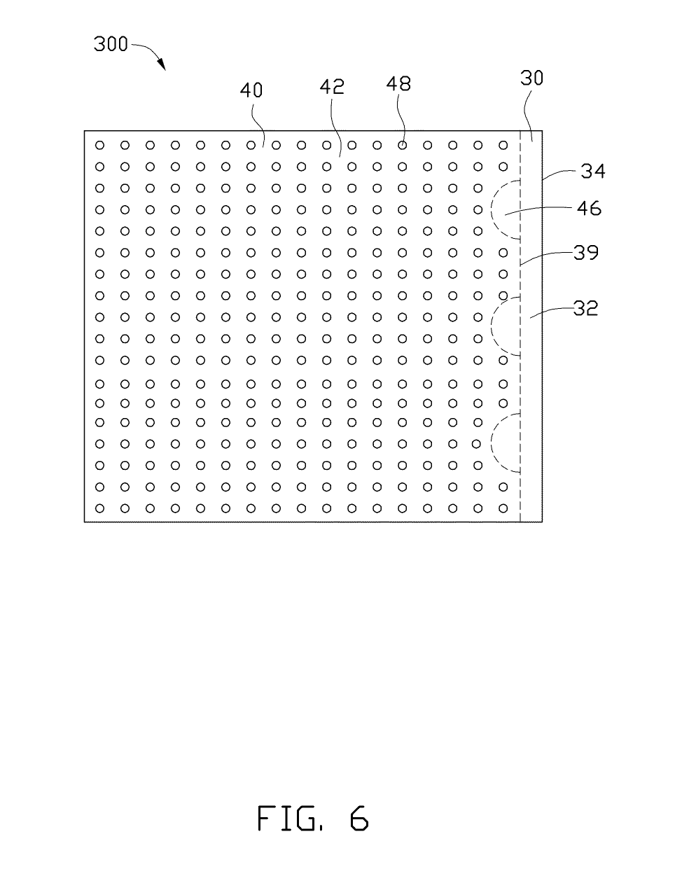

Referring to FIGS. 5 and 6, a light guide plate 300 according to a third embodiment of the present disclosure is shown. The light guide plate 300 includes a light mixing part 30 and a visual part 40 connected to the light mixing part 30. In this embodiment, the light mixing part 30 and the visual part 40 are integrally formed by injection molding.

The light mixing part 30 is a substantially rectangular block. The light mixing part 30 includes a light mixing bottom surface 32, a light incident surface 34, a top surface 36, and an adjoining surface 38. The light mixing bottom surface 32 is opposite to the top surface 36. The light mixing bottom surface 32 and the top surface 36 are substantially rectangular. The light incident surface 34 is substantially rectangular and is substantially perpendicular to the light mixing bottom surface 32 and the top surface 36. The light mixing part 30 is connected to the visual part 40 at the adjoining surface 38. The light incident surface 34 is opposite and substantially parallel to the adjoining surface 38.

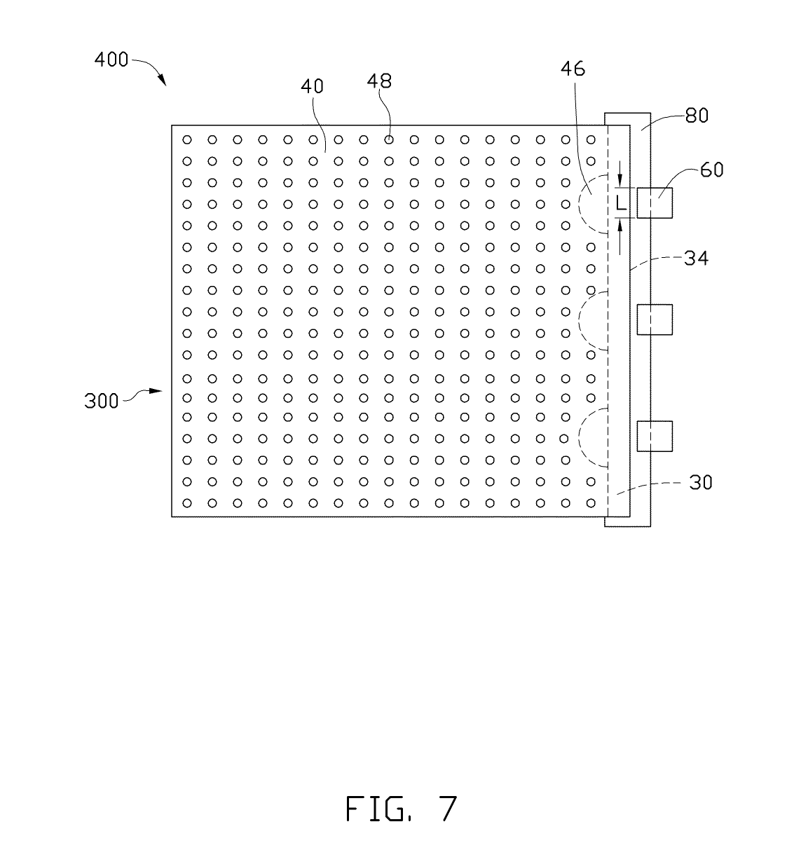

The visual part 40 is a substantially flat plate. The visual part 40 and the light mixing part 30 are both substantially cubic. The visual part 40 includes a visual bottom surface 42 and a light emitting surface 44. The visual bottom surface 42 is opposite and parallel to the light emitting surface 44. The visual bottom surface 42 is substantially coplanar with the light mixing bottom surface 32. The visual bottom surface 42 and the light mixing bottom surface 32 are divided by an imaginary adjoining line 39. The light emitting surface 44 is substantially coplanar with the top surface 36. The visual bottom surface 42 includes three evenly spaced substantially semi-circular non-dot areas 46 bordering the imaginary adjoining line 39. A number of reflective dots 48 are formed on the visual bottom surface 42 except for the three non-dot areas 46. A length of a straight edge of each non-dot area 26 is about 1 to about 1.5 times a width of a light source 60 (see FIG. 7). Areas of the non-dot areas 46 are substantially equal to each other.

Referring to FIGS. 5 and 7, a backlight module 400 according to a fourth embodiment is disclosed. The backlight module 400 includes the light guide plate 300, three light sources 60, and a shield part 80.

The light sources 60 are located adjacent to the light incident surface 34, and light emitting surfaces of the light sources 60 face the light incident surface 34. In one embodiment, the light sources 60 are LEDs. The non-dot areas 46 are aligned one-to-one with the light sources 60 along a direction substantially perpendicular to the light emitting surface of the light sources 60. Light emitted by the light sources 60 enters the light guide plate 300 from the light incident surface 34 and is transmitted to the visual part 40 through the light mixing part 30. In the visual part 40, the light is reflected and scattered by the reflective dots 48 and is emitted out from the light emitting surface 44.

The shield part 80 completely covers the top surface 36. In one embodiment, the shield part 80 also partly covers the light sources 60. The shield part 80 is fixedly mounted on a side frame (not shown) of the backlight module 400. The shield part 80 can be black-colored to absorb light emitted out from the top surface 36 to prevent light leaking out of the backlight module 400. The shield part 80 can also be a reflecting layer to reflect light emitted out from the top surface 36 back to the light mixing part 30 to increase a usage ratio of the light.

The visual bottom surface 42 has non-dot areas 46 aligned with the light sources 60, so bright spots are eliminated or at least reduced. Additionally, the non-dot areas 46 are aligned with and adjacent to the light sources 60, so there is plenty of light to illuminate the non-dot areas 46 to prevent dark spots from forming. Furthermore, the light guide plate 300 is suitable for use with a multi-light source.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A light guide plate comprising:
a light mixing part comprising a light mixing bottom surface, a light incident surface, and a top surface opposite to the light mixing bottom surface, the light incident surface being perpendicular to the light mixing bottom surface and the top surface; and
a visual part adjoining to the light mixing part, the visual part comprising a visual bottom surface and a light emitting surface opposite to the visual bottom surface, the visual bottom surface and the light mixing bottom surface being coplanar to each other and being divided by an imaginary adjoining line, the top surface and the light emitting surface being coplanar, the visual bottom surface having at least one non-dot area, the visual bottom surface forming a plurality of reflective dots except for the non-dot area.

2. The light guide plate of claim 1, wherein visual part is a flat plate.

3. The light guide plate of claim 1, wherein the non-dot area is semi-circular, and a straight edge of the non-dot area is collinear with the imaginary adjoining line.

4. The light guide plate of claim 1, wherein the light mixing part is a prism.

5. The light guide plate of claim 1, wherein the light mixing part is a cube.

6. A backlight module comprising:
a light guide plate comprising:
a light mixing part comprising a light mixing bottom surface, a light incident surface, and a top surface opposite to the light mixing bottom surface, the light incident surface being perpendicular to the light mixing bottom surface and the top surface; and
a visual part adjoining to the light mixing part, the visual part comprising a visual bottom surface and a light emitting surface opposite to the visual bottom surface, the visual bottom surface and the light mixing bottom surface being coplanar to each other and being divided by an imaginary adjoining line, the top surface and the light emitting surface being coplanar to each other, the visual bottom surface having at least one non-dot area, the visual bottom surface forming a plurality of reflective dots except for the non-dot area; and
at least one light source adjacent to the light incident surface and aligned with the non-dot area.

7. The backlight module of claim 6, wherein visual part is a flat plate.

8. The backlight module of claim 6, wherein the non-dot area is semi-circular, a straight edge of the non-dot area is collinear with the imaginary adjoining line, and a length of the straight edge is 1 to 1.5 times the width of the light source.

9. The backlight module of claim 6, wherein the light mixing part is a prism, the number of the light source is one, and the number of the non-dot area is one.

10. The backlight module of claim 6, wherein the light mixing part is a cube, the number of the light source is more than one, and the number of the non-dot area is equal to the number of the light source.

11. The backlight module of claim 6, wherein the light source is light emitting diode.

12. The backlight module of claim 6, further comprising a shield part completely covering the top surface for preventing light emitted out from the top surface.
